(19) United States
(12) Patent Application Publication
(10) Pub. No.: US 2015/0077835 A1
(43) Pub. Date: Mar. 19, 2015

(54) ELECTROPHORESIS DISPLAY DEVICE AND ELECTRONIC APPARATUS

(71) Applicant: Seiko Epson Corporation, Tokyo (JP)

(72) Inventor: Katsunori Yamazaki, Matsumoto-shi (JP)

(21) Appl. No.: 14/484,728

(22) Filed: Sep. 12, 2014

(30) Foreign Application Priority Data
Sep. 18, 2013 (JP) 2013-192664

(51) Int. Cl. G02F 1/167; G02F 1/1335

(52) U.S. Cl. CPC G02F 1/167; G02F 1/133504; G02F 1/133553; G02F 1/133555
USPC 359/296

(57) ABSTRACT

There is provided an electrophoresis display device including a first substrate and a second substrate that are arranged counter to each other, an electrophoresis layer that is arranged in a display region, between the first substrate and the second substrate, and a scattering layer that is arranged at least in a portion of an outer periphery of the display region, between the electrophoresis layer and the second substrate, and scatters light which is incident from the second substrate side.

### BACKGROUND

1. Technical Field

The present invention relates to an electrophoresis display device and an electronic apparatus.

2. Related Art

In the related art, as an electrophoresis display device, a device that encloses a dispersion liquid dispersing electrophoresis particles in a region which is divided by a partition wall formed between a pair of substrates, is known (for example, see JP-A-2013-7985).

However, in the electrophoresis display device of the related art described above, a problem that brightness of a periphery portion in a display region becomes darker than that of a center portion, occurs.

### SUMMARY

An advantage of some aspects of the invention is to provide an electrophoresis display device and an electronic apparatus that obtain a good display quality by uniformizing brightness of a display region.

As a result of diligent study, the present inventors found out the reason why the brightness is different within the display region is that approximately 60% of light incident to a predetermined target pixel is caused by the light reflected from periphery pixels of the target pixel. That is, the findings that the pixel in a center of the display region can receive approximately 60% of the light from the periphery pixels, and, on the contrary, the pixels of four corners of the display region can receive only approximately 15% of the light which is ¼ thereof, are obtained. Therefore, on the basis of the findings, the invention is completed.

According to a first aspect of the invention, there is provided an electrophoresis display device including a first substrate and a second substrate that are arranged counter to each other, an electrophoresis layer that is arranged in a display region, between the first substrate and the second substrate, and a scattering layer that is arranged at least in a portion of an outer periphery of the display region, between the electrophoresis layer and the second substrate, and scatters light which is incident from the second substrate side.

According to the electrophoresis display device relating to the first aspect, it is possible to scatter the light which is total-reflected with a surface of the second substrate among the light scattered on the electrophoresis layer, by the scattering layer. Hereby, a portion of the scattered light is reflected and returned to the display region side by the scattering layer. Accordingly, since an outer periphery portion of the display region becomes bright, it is possible to uniformize the brightness of the display region, and to display in high quality.

In the electrophoresis display device according to the first aspect, it is preferable that the scattering layer reflects the light toward the display region side.

According to the configuration, since the scattered light is returned to the display region side, the periphery portion of the display region can be brighter.

In the electrophoresis display device according to the first aspect, it is preferable that a reflecting plate that is arranged on an opposite side to the display region of the scattering layer in a state of plan view, so as to intersect with the scattering layer, is further included.

According to the configuration, it is possible to return the light which is scattered on an outside of the display region, to the display region side. Accordingly, utilization efficiency of the light can be increased, and the periphery portion of the display region can be brighter.

In the electrophoresis display device according to the first aspect, it is preferable that the reflecting plate is arranged on a side end face of the second substrate.

According to the configuration, since the light which externally escapes from the side end face of the second substrate, can be returned to an inside, the utilization efficiency of the light can be improved, and the display region can be brighter.

In the electrophoresis display device according to the first aspect, it is preferable that a transflective printing layer that is arranged on a face of the opposite side to the electrophoresis layer of the second substrate, is further included.

According to the configuration, it is possible to bring in the external light through the transflective printing layer.

In the electrophoresis display device according to the first aspect, it is preferable that the transflective printing layer is arranged in a region overlapping the scattering layer, in the state of plan view.

According to the configuration, it is possible to make the scattering layer unnoticeable by the transflective printing layer, and to improve design properties.

According to a second aspect of the invention, there is provided an electronic apparatus including the electrophoresis display device according to the first aspect.

According to the electronic apparatus relating to the second aspect, since the electronic apparatus includes the electrophoresis display device described above, the electronic apparatus also has high reliability of being able to perform the display of the uniform brightness.

### BRIEF DESCRIPTION OF THE DRAWINGS

The invention will be described with reference to the accompanying drawings, wherein like numbers reference like elements.

FIG. 1 is a cross-sectional view illustrating an outline configuration of an electrophoresis display device according to a first embodiment.

FIG. 2 is a diagram illustrating a planar structure of a frame structure configuring a display region of the electrophoresis display device.

FIG. 3 is a cross-sectional view taken along the III-III line arrow of FIG. 2.

FIG. 4 is a schematic cross-sectional view for describing a phenomenon that occurs in an electrophoresis display device of the related art.

FIG. 5 is a cross-sectional view illustrating a configuration of a main portion of a scattering layer.

FIG. 6 is a cross-sectional view illustrating an outline configuration of an electrophoresis display device according to a second embodiment.

FIG. 7 is a cross-sectional view illustrating an outline configuration of an electrophoresis display device according to a third embodiment.

FIG. 8A and FIG. 8B are diagrams illustrating a configuration of a main portion of the electrophoresis display device according to the third embodiment.

FIG. 9A is a perspective view illustrating an electronic book which is an example of an electronic apparatus, FIG. 9B is a perspective view illustrating a wristwatch which is an example of the electronic apparatus, and FIG. 9C is a perspective view illustrating an electronic paper which is an example of the electronic apparatus.

### DESCRIPTION OF EXEMPLARY EMBODIMENTS

Hereinafter, one embodiment of an electrophoresis display device and an electronic apparatus of the invention, will be described with reference to drawings.

Furthermore, there is a case that enlargedly shows a portion which becomes features for convenience, in order to easily understand the features, and the drawing which is used in the following description, is not limited to such a case that a dimension ratio of each configuration component is the same as reality.

### First Embodiment

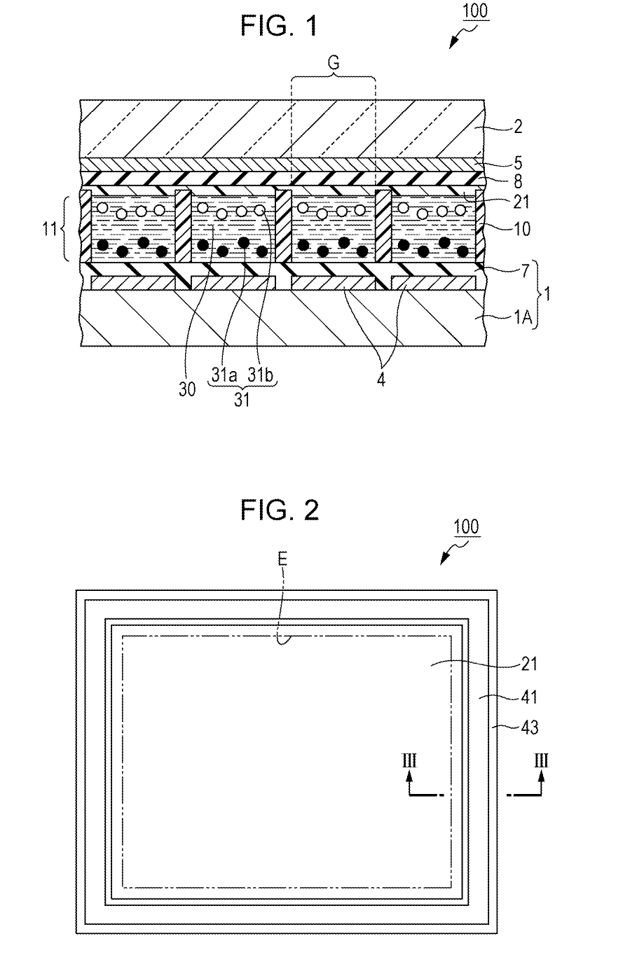

FIG. 1 is a cross-sectional view illustrating an outline configuration of an electrophoresis display device according to a first embodiment. As shown in FIG. 1, an electrophoresis display device 100 includes an element substrate 1, a counter substrate 2, and an electrophoresis layer 11 that is arranged between the element substrate 1 and the counter substrate 2.

The element substrate (first substrate) 1 includes a base material 1A, a pixel electrode (first electrode) 4 that is arranged on the electrophoresis layer 11 side of the base material 1A, and a first insulating film 7 that covers the pixel electrodes 4. Since the base material 1A is a substrate which is made up of glass, plastic, or the like, and is arranged on a side opposite to an image display face, the base material 1A may not be transparent. The pixel electrode 4 is made by laminating nickel-plating and gold-plating in this order on Cu foil, or is an electrode which is formed by Al, ITO (indium tin oxide) or the like. Illustration is omitted, but a scanning line, a data line, a selection transistor, and the like are formed, between the pixel electrode 4 and the base material 1A.

The counter substrate (second substrate) 2 is configured of a transparent base material such as glass and plastic, and is arranged on the image display side. On the electrophoresis layer 11 side of the counter substrate 2, a common electrode 5 having a planar shape that counters to a plurality of the pixel electrodes 4, is formed. A whole face of the common electrode 5 is covered by a second insulating film 8. The common electrode 5 is a transparent electrode which is formed of MgAg, ITO, IZO (indium zinc oxide), or the like.

The electrophoresis layer 11 is filled in a space which is partitioned with the first insulating film 7 that is arranged on an inner face side of the element substrate 1, the second insulating film 8 that is arranged on an inner face side of the counter substrate 2, and a partition wall 10 that is arranged between the first insulating film 7 and the second insulating film 8. The partition wall 10 divides a pixel G which is arranged corresponding to each pixel electrode 4, and is formed of a translucency material (acryl, epoxy resin, or the like).

For example, a thickness of the partition wall 10 is 30 μm. Furthermore, between an upper portion of the partition wall 10 and the second insulating film 8, a joining layer 21 is arranged. The joining layer 21 is made in order to join the counter substrate 2 to the element substrate 1 where the partition wall 10 is formed. For example, the joining layer 21 is configured of a transparent resin, and the upper portion of the partition wall 10 encroaches upon the joining layer 21. The thickness of the joining layer 21 may be a degree which does not disturb an electric field, and is preferably, for example, approximately 2 μm to 6 μm. Moreover, an encroaching amount of the partition wall 10 upon the joining layer 21 is preferably, for example, 0.5 μm to 1 μm.

The electrophoresis layer 11 is configured of a plurality of electrophoresis particles 31 that are dispersed among a dispersion medium 30. In the embodiment described herein, the electrophoresis particle 31 includes, for example, a white color particle 31a and a black color particle 31b.

For example, the white color particle 31a is a particle (high polymer or colloid) which is made up of white color pigments such as titanium oxide, zinc flower, and antimony trioxide, and is used, for example, to be negatively charged with electricity. For example, the black color particle 31b is a particle (high polymer or colloid) which is made up of black color pigments such as aniline black and carbon black, and is used, for example, to be positively charged with electricity. To the pigments, electric charge control agent which is made up of particles such as electrolyte, surfactant, metal soap, resin, rubber, oil, varnish, and compound, a dispersing agent such as titanium-based coupling agent, aluminum-based coupling agent, and silane-based coupling agent, a lubricant, a stabilizing agent, or the like, can be added, as necessary.

Furthermore, instead of the white color particle 31a and the black color particle 31b, for example, the pigments such as red color, green color, and blue color may be used. According to the configuration, it is possible to provide the electrophoresis display device 100 that can perform a color display by displaying the red color, the green color, the blue color, or the like.

As the dispersion medium 30, water, an alcohol-based solvent (such as methanol, ethanol, isopropanol, butanol, octanol, and methyl cellosolve), esters (such as ethyl acetate, and butyl acetate), ketones (such as acetone, methyl ethyl ketone, and methyl isobutyl ketone), aliphatic hydrocarbon (such as pentane, hexane, and octane), alicyclic hydrocarbon (such as cyclohexane, and methylcyclohexane), aromatic hydrocarbon (benzene, toluene, xylene, and benzenes having long chain alkyl group (such as hexyl benzene, heptyl benzene, octyl benzene, nonyl benzene, decyl benzene, undecyl benzene, dodecyl benzene, tridecyl benzene, and tetra decyl benzene)), halogenated hydrocarbon (such as methylene chloride, chloroform, carbon tetrachloride, and 1,2-dichloroethane), or the like, can be used as an example, and other oils may be used. The substances can be used alone or as a mixture, and further, the surfactant such as carboxylate, or the like may be mixed.

Based on the configuration, in the electrophoresis display device 100, for example, if a voltage is applied between the pixel electrode 4 and the common electrode 5, in accordance with the electric field occurring therebetween, the electrophoresis particle 31 (white color particle 31a and black color particle 31b) is electrophoresed toward any one of the electrodes (pixel electrode 4, common electrode 5). For example, if the pixel electrode 4 is at a negative potential when the white color particle 31a has a positive charge, the white color particle 31a is moved and gathered to the pixel electrodes 4 side (lower side), and a black display is made.

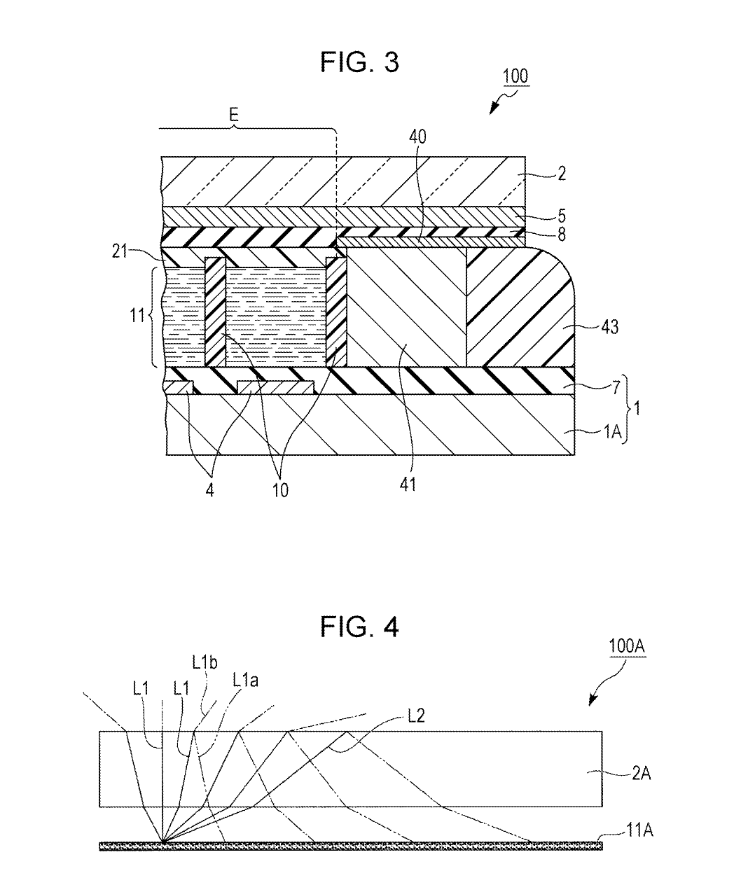

FIG. 2 is a diagram illustrating a planar structure of a frame structure configuring a display region of the electrophoresis display device 100. FIG. 3 is a cross-sectional view taken along the III-III line arrow of FIG. 2.

As shown in FIG. 2 and FIG. 3, in the electrophoresis display device 100, a seal material 41 is arranged so as to surround a display region E. The seal material 41 is used for sticking the element substrate 1 and the counter substrate 2 together, and is arranged in a state of coming into contact with the partition wall 10 which divides the pixel G positioned at an outermost periphery of the display region E. For example, a width of the seal material 41 is 450 μm. The thickness of the seal material 41 is, for example, 20 μm to 50 μm.

In the embodiment described herein, an outer shape of the counter substrate 2 is smaller than that of the element substrate 1, as shown in FIG. 3. On an outside of the seal material 41, a sealing material 43 that is made up of mold resin in order to enhance sealing properties between the element substrate 1 and the counter substrate 2, is arranged. For example, the width of the sealing material 43 is 250 μm.

Incidentally, in a electrophoresis display device of the related art, generally, a problem that brightness of a periphery portion of the display region becomes darker than that of a center portion, occurs.

FIG. 4 is a schematic cross-sectional view for describing a phenomenon that occurs in a general electrophoresis display device 100A of the related art.

As shown in FIG. 4, in the electrophoresis display device 100A, external light incident from a counter substrate 2A side which is a display face, is scattered and reflected with an electrophoresis layer 11A. The light which is scattered and reflected with the electrophoresis layer 11A, is incident to an inside of the counter substrate 2A again, a light beam L1a of a portion is reflected and returned to the inside among a light beam L1 having an angle which is less than an critical angle at an interface between the counter substrate 2A and air, and a light beam L1b of a remaining portion is emitted as image light from the display face. On the other hand, a light beam L2 having an angle which is equal to or more than the critical angle, is irradiated to the electrophoresis layer 11A again by total-reflecting.

In electrophoresis display device 100A, for example, a ratio where the light which is reflected with the electrophoresis layer 11A is directly emitted from the display face, is approximately 38%, and the ratio where the light is returned to the inside of the display face is approximately 62%. Furthermore, it is repeated that the light which is returned to the inside of the display face, is reflected with the electrophoresis layer 11A again.

The light which comes out from the electrophoresis layer 11A of a certain position, returns to the electrophoresis layer 11A of other position. That is, it can be stated in other words that the degree of 62% of the brightness corresponding to the electrophoresis layer 11A of a certain position is configured by the reflected light of the electrophoresis layer 11A of other position.

Therefore, the pixel in the center of the display region receives 62% of the light from periphery pixels, and, on the contrary, the pixels of the periphery portion of the display region, for example, four corners, receive only 15% of the light which is ¼ thereof. As described above, the findings that the pixels of the periphery portion are darker than the pixel of the central portion, and thereby, it becomes a cause of ununiformity of the brightness within the display region, are obtained.

On the basis of the findings, the electrophoresis display device 100 according to the embodiment described herein, includes a scattering layer 40 that is arranged on an outer periphery of the display region E. The scattering layer 40 is made to scatter the light which is incident from the counter substrate 2 side. Here, the light which is incident from the counter substrate 2 side, includes not only the light which is incident to the scattering layer 40 after being incident to the periphery portion of the display region E by penetrating the counter substrate 2, and being reflected at least once with the electrophoresis layer 11, but also the light which is directly incident to the scattering layer 40 by penetrating the counter substrate 2.

Furthermore, as the scattering layer 40, it is preferable to use the same color material as the electrophoresis particle 31 (white color particle 31a or black color particle 31b). Hereby, a boundary between the display region E which is configured of the electrophoresis particle 31, and the scattering layer 40, can be difficult to see.

In the embodiment described herein, for example, the scattering layer 40 is configured by applying or printing the white color pigments such as titanium oxide configuring the white color particle 31a, using acryl as a binder.

Moreover, by blending titanium oxide in the seal material 41, a portion of the scattering layer 40 may be configured by the seal material 41.

In the embodiment described herein, the scattering layer 40 is formed in a frame shape surrounding the periphery of the display region E in a state of plan view. The scattering layer 40 is formed on the second insulating film 8 on the counter substrate 2.

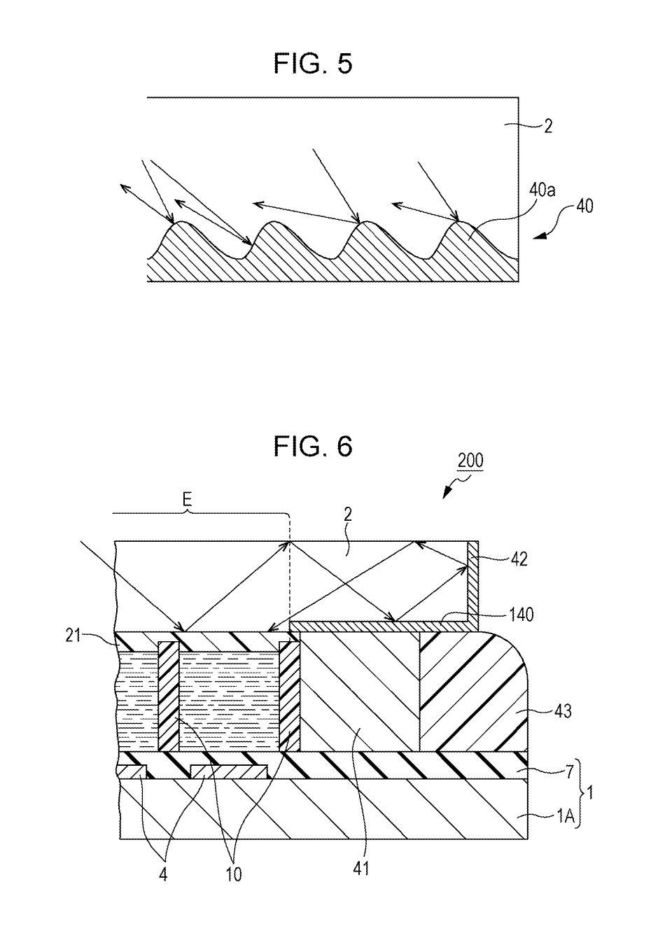

FIG. 5 is a cross-sectional view illustrating a configuration of a main portion of the scattering layer 40. As shown in FIG. 5, the scattering layer 40 has a plurality of convex portions 40a. The plurality of the convex portions 40a are oriented so as to have a shape (backward scattering) of reflecting the light toward the display region E side. Hereby, the light which is incident to the scattering layer 40 by being reflected with the pixel G in the periphery portion of the display region E, is returned to the display region E side, again.

Here, it is preferable that the scattering layer 40 is arranged so as to make a gap occurring between the display region E, small. In the state of plan view, if a large gap occurs between the scattering layer 40 and the display region E, the gap portion cannot return a total reflection component on a surface of the counter substrate 2 of the scattered light from a predetermined pixel of the display region E, to the display region E side. That is, the light cannot be efficiently returned to the display region E, and the light cannot be effectively used.

When the light is efficiently returned to the display region E, the gap between the scattering layer 40 and the display region E, is preferably the degree of five times of the thickness of the counter substrate 2 at most, and is further preferably equal to or less than four times thereof. The gap may not be arranged between the scattering layer 40 and the display region E.

In the embodiment described herein, an inner edge portion of the scattering layer 40 is formed so as to overlap an outer periphery end portion of the display region E in the state of plan view. That is, the scattering layer 40 is formed up to an edge of the display region E, and is in the state of arranging no gap between the display region E.

According to the embodiment described herein, the light which comes out the outside of the display region E by being total-reflected with the surface of the counter substrate 2 among the light scattered with the electrophoresis layer 11 in the pixel G of an outer periphery portion of the display region E, can be returned to the display region E side by the scattering layer 40. Hereby, it is possible to improve the brightness of the pixel G of the outer periphery portion of the display region E where the scattering layer 40 is arranged.

Therefore, it is possible to prevent generating a defect of the ununiformity of the brightness within the display region E which occurs in the general electrophoresis display device 100 as described above.

As described above, since the electrophoresis display device 100 unifomizes the brightness of the display region E, it is possible to perform the display of high quality as a result.

### Second Embodiment

Subsequently, an electrophoresis display device according to a second embodiment, will be described. In the embodiment described herein, a point that a reflecting plate is included in addition to the scattering layer 40, is different. Furthermore, the same reference signs are attached to the same members as the above embodiment, and the detailed description thereof is omitted.

FIG. 6 is a diagram illustrating a cross section structure of an electrophoresis display device according to the embodiment described herein, and corresponds to FIG. 3 of the first embodiment. As shown in FIG. 6, an electrophoresis display device 200 includes a scattering layer 140 that is arranged on the outer periphery of the display region E, and a reflecting plate 42 that is arranged on an opposite side to the display region E of the scattering layer 140 in a state of plan view, so as to intersect with the scattering layer 140. The reflecting plate 42 can return the light which externally escapes from a side end face of the counter substrate 2, to the inside.

In the embodiment described herein, the reflecting plate 42 is arranged on the side end face of the counter substrate 2. In the same manner as the scattering layer 40, for example, the reflecting plate 42 is configured by applying or printing the white color pigments such as titanium oxide, using acryl as a binder.

According to the embodiment described herein, since it is possible to return the light which externally escapes from the side end face of the counter substrate 2, to the inside, by the reflecting plate 42, the light which is incident from the counter substrate 2 side, can be more efficiently used, and the brightness of the display region E can be further improved.

Moreover, after reflecting with the scattering layer 140, the light incident to the side end face of the counter substrate 2, can be returned to the inside by the reflecting plate 42. Accordingly, as the scattering layer 140, a shape which is different from the shape (backward scattering) of reflecting the light toward the display region E side as the first embodiment, can be adopted. Consequently, it is possible to improve degrees of freedom in design of the scattering layer 140.

In the embodiment described above, the reflecting plate 42 is arranged on the side end face of the counter substrate 2, but aspects of the reflecting plate 42 are not limited thereto. For example, the reflecting plate 42 may be arranged between the outside of the display region E and a side end portion of the counter substrate 2. Alternatively, between the outside of the display region E and the side end portion of the counter substrate 2, the plurality of the reflecting plates 42 may be arranged changing the positions.

### Third Embodiment

Subsequently, an electrophoresis display device according to a third embodiment, will be described. In the embodiment described herein, the point that a decorative sheet is further included, is different from the second embodiment. Furthermore, the same reference signs are attached to the same members as the above embodiment, and the description thereof is omitted.

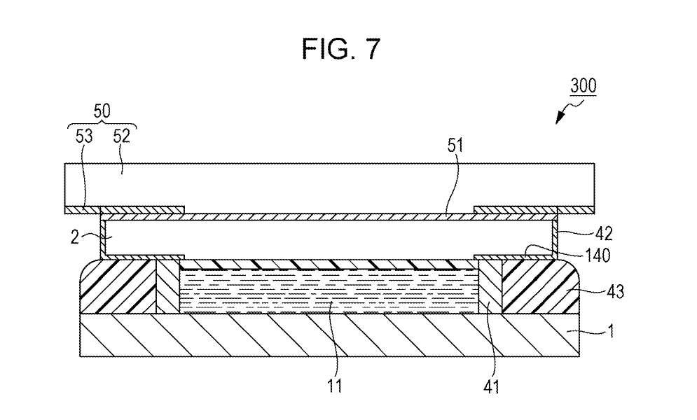

FIG. 7 is a diagram illustrating a cross section structure of an electrophoresis display device according to the embodiment described herein. As shown in FIG. 7, an electrophoresis display device 300 includes the element substrate 1, the counter substrate 2, the electrophoresis layer 11 that is arranged between the element substrate 1 and the counter substrate 2, and a decorative sheet 50 that is pasted to the face of the opposite side to the electrophoresis layer 11 of the counter substrate 2 through an adhesive layer 51.

In the embodiment described herein, the decorative sheet 50 is formed to have the larger planar shape than the counter substrate 2. The decorative sheet 50 includes a transparent base material 52, and a transflective printing layer 53. The transflective printing layer 53 has a light transparency, is penetrated with the light incident from an upper face side of the transparent base material 52, and makes the light be incident to the counter substrate 2 side. The transflective printing layer 53 is formed so as to overlap the scattering layer 40 in the state of plan view.

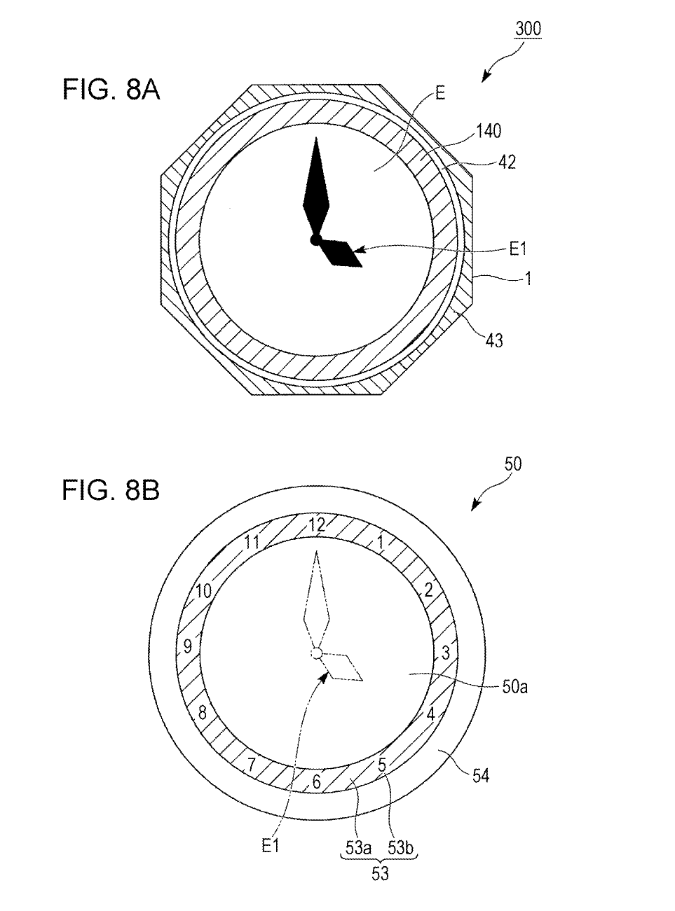

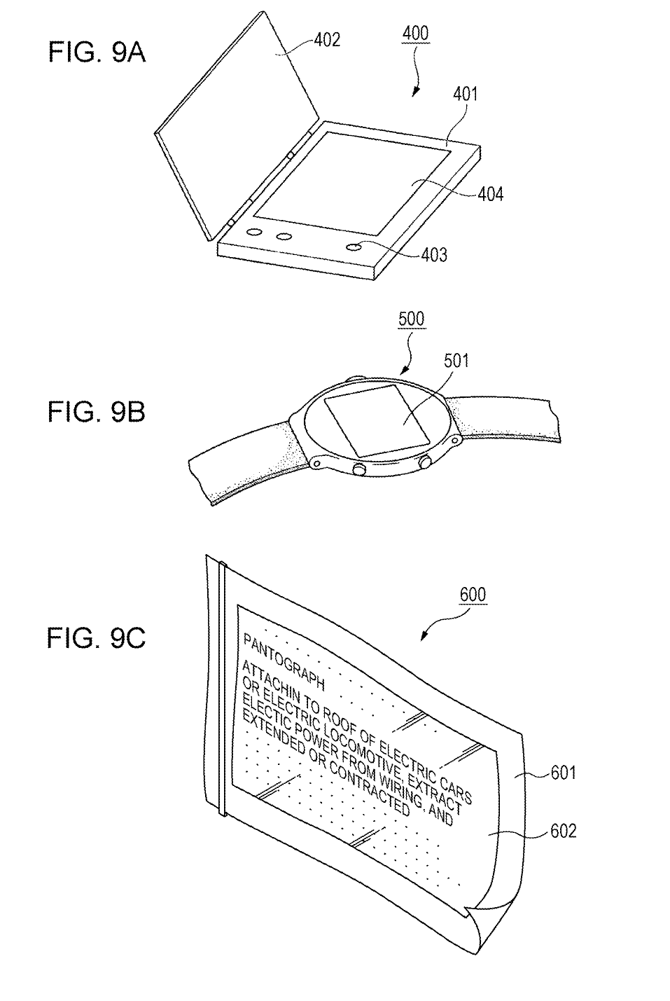

FIG. 8A and FIG. 8B are diagrams illustrating a configuration of a main portion of the electrophoresis display device 300 according to the embodiment described herein. FIG. 8A is a plan view of the electrophoresis display device 300 except for the decorative sheet 50 when seen from the counter substrate 2 side, and FIG. 8B is a plan configuration view of the decorative sheet 50. The electrophoresis display device 300 is applied to a wristwatch (see FIG. 9B) which is an example of an electronic apparatus described later.

As shown in FIG. 8A, in the electrophoresis display device 300 according to the embodiment described herein, an outer shape which is defined by the counter substrate 2 is a regular octagon. In the embodiment described herein, the electrophoresis display device 300 includes the display region E having a circular shape. In the display region E, as a display image E1, a clock long hand and a clock short hand for a wristwatch are displayed. Moreover, the scattering layer 140 is arranged in a ring shape so as to surround the outer periphery portion of the display region E. When seen from the counter substrate 2 side, the scattering layer 140 is confirmed by sight in ring shape of white color.

On the other hand, as shown in FIG. 8B, the decorative sheet 50 has the outer shape of a disk shape. The decorative sheet 50 has a display portion 50a corresponding to the display region E, the transflective printing layer 53 that is arranged on the outside of the display portion 50a, and a printing layer 54 having a ring shape which is arranged on the outside of the transflective printing layer 53. The display portion 50a has the same size as the display region E, and is configured of a member having high degree of transparency, or an opening. Differently from the transflective printing layer 53, the printing layer 54 is configured of a material without being penetrated with the light. On the printing layer 54, a predetermined design pattern or the like is printed.

In the embodiment described herein, the transflective printing layer 53 includes a main body portion 53a corresponding to the scattering layer 40, and a character portion 53b that indicates a number indicating time in company with the clock long hand and the clock short hand displayed in the display region E. In the embodiment described herein, the scattering layer 40 is configured of the white color material. Therefore, when the decorative sheet 50 is seen in plan view, the main body portion 53a of the transflective printing layer 53 is confirmed by sight in the white color on the whole by the scattering layer 40 which is arranged on a lower layer.

Moreover, the main body portion 53a is set to have relatively low degree of transparency or relatively high degree of transparency, in comparison with the character portion 53b. Hereby, it is possible to display only a time number portion of the character portion 53b brightly or darkly, it is possible to improve visibility of the time number portion, and it is possible to enhance design properties.

As described above, according to the embodiment described herein, there is provided the electrophoresis display device 300 having the excellent design properties by arranging the decorative sheet 50. Since the decorative sheet 50 has the transflective printing layer 53 which is arranged corresponding to the scattering layer 40, it is possible to bring in the light to the inside through the transflective printing layer 53. Moreover, since the decorative sheet 50 is set to have the larger outer shape than the counter substrate 2, it is possible to improve the brightness of the display region E by positively guiding the light to the scattering layer 40.

Furthermore, the invention is not necessarily limited to the above embodiments, and it is possible to add various modifications within a range without departing from the gist of the invention.

For example, in the above embodiments, the case where the scattering layer 40 is formed by printing or the like, is used as an example, but it is not limited thereto, and the scattering layer 40 may be formed by cutting the surface of the counter substrate 2. Moreover, in a concave and convex shape formed in this manner, the scattering layer 40 may be formed by forming a film with Al or the like by vapor deposition. In this case, in order to prevent a short circuit with the scattering layer 40, the common electrode 5 is not arranged in a forming area of the scattering layer 40.

In the above embodiments, the case where the scattering layer 40 is arranged so as to surround the whole of the outer periphery of the display region E, is described, but it is not limited thereto, and the scattering layer 40 may be arranged at least in a portion of the outer periphery of the display region E. According thereto, since the light is returned to the display region E side at least in the position where the scattering layer 40 is arranged, it is possible to improve the brightness of the display region E.

### Electronic Apparatus

Next, the case where the electrophoresis display device of the above each embodiment is applied to an electronic apparatus, will be described.

FIG. 9A, FIG. 9B, and FIG. 9C are perspective views describing a concrete example of an electronic apparatus to which the electrophoresis display device of the invention is applied.

FIG. 9A is a perspective view illustrating an electronic book which is an example of an electronic apparatus. An electronic book (electronic apparatus) 400 includes a frame 401 having a book shape, a (openable and closeable) cover 402 that is arranged rotatably with respect to the frame 401, an operation portion 403, and a display portion 404 that is configured by the electrophoresis display device of the invention.

FIG. 9B is a perspective view illustrating a wristwatch which is an example of the electronic apparatus. A wristwatch (electronic apparatus) 500 includes a display portion 501 that is configured by the electrophoresis display device of the invention.

FIG. 9C is a perspective view illustrating an electronic paper which is an example of the electronic apparatus. An electronic paper (electronic apparatus) 600 includes a main body portion 601 that is configured of a rewritable sheet having a texture and flexibility in the same manner as paper, and a display portion 602 that is configured by the electrophoresis display device of the invention.

For example, in the electronic paper, the electronic book, or the like, since the use thereof is assumed by repeatedly writing in the characters on a white background, it is necessary for a solution to display unevenness.

Furthermore, the scope of the electronic apparatus to which the electrophoresis display device of the invention can be applied, is not limited thereto, and widely includes a device that uses a variation in color tone visually accompanied with movement of the charged particles.

According to the electronic book 400, the wristwatch 500, and the electronic paper 600, since the electrophoresis display device relating to the invention is employed, it becomes a high resolution electronic apparatus with excellent reliability that can obtain display properties of high quality by suppressing the display unevenness.

Furthermore, the above electronic apparatuses are used as an example of the electronic apparatus relating to the invention, and do not limit the technology scope of the invention. For example, the electrophoresis display device according to the invention can be suitably used for a display unit of the electronic apparatuses such as a mobile phone and a portable audio apparatus, a sheet for business use such as a manual, a textbook, a workbook, an information sheet, or the like.

The entire disclosure of Japanese Patent Application No. 2013-192664, filed Sep. 18, 2013 is expressly incorporated by reference herein.

What is claimed is:

1. An electrophoresis display device comprising:
a first substrate and a second substrate that are arranged counter to each other;
an electrophoresis layer that is arranged in a display region, between the first substrate and the second substrate; and
a scattering layer that is arranged at least in a portion of an outer periphery of the display region, between the electrophoresis layer and the second substrate, and scatters light which is incident from the second substrate side.

2. The electrophoresis display device according to claim 1,
wherein the scattering layer reflects the light toward the display region side.

3. The electrophoresis display device according to claim 1, further comprising:
a reflecting plate that is arranged on an opposite side to the display region of the scattering layer in a state of plan view, so as to intersect with the scattering layer.

4. The electrophoresis display device according to claim 3,
wherein the reflecting plate is arranged on a side end face of the second substrate.

5. The electrophoresis display device according to claim 1, further comprising:
a transflective printing layer that is arranged on a face of the opposite side to the electrophoresis layer of the second substrate.

6. The electrophoresis display device according to claim 5,
wherein the transflective printing layer is arranged in a region overlapping the scattering layer, in the state of plan view.

7. An electronic apparatus comprising:
the electrophoresis display device according to claim 1.

8. An electronic apparatus comprising:
the electrophoresis display device according to claim 2.

9. An electronic apparatus comprising:
the electrophoresis display device according to claim 3.

10. An electronic apparatus comprising:
the electrophoresis display device according to claim 4.

11. An electronic apparatus comprising:
the electrophoresis display device according to claim 5.

12. An electronic apparatus comprising:
the electrophoresis display device according to claim 6.
